(19) United States
(12) Patent Application Publication
(10) Pub. No.: US 2016/0124409 A1
(43) Pub. Date: May 5, 2016

(54) METHOD AND SYSTEM FOR THE EXTERNAL EXCHANGE OR UPDATE OF A DEVICE

(71) Applicant: ABB TECHNOLOGY AG, Zuerich (CH)

(72) Inventor: Dirk Schulz, Meckenheim (DE)

(21) Appl. No.: 14/931,902

(22) Filed: Nov. 4, 2015

(30) Foreign Application Priority Data
Nov. 5, 2014 (DE) 10 2014 016 402.0

(51) Int. Cl. G05B 19/048

(52) U.S. Cl. CPC G05B 19/048; G05B 2219/24019; G05B 2219/24001

(57) ABSTRACT

A method exchanges or updates an old device of a process control system, wherein information is collected about the type and the entity of the old device as well as the type of a new device, wherein the information is compiled into a request, and the request is forwarded to an external service system, with which the request is analyzed and processed, whereupon a new device is compiled externally and is transferred to the process control system in a transfer and is integrated into the process control system.

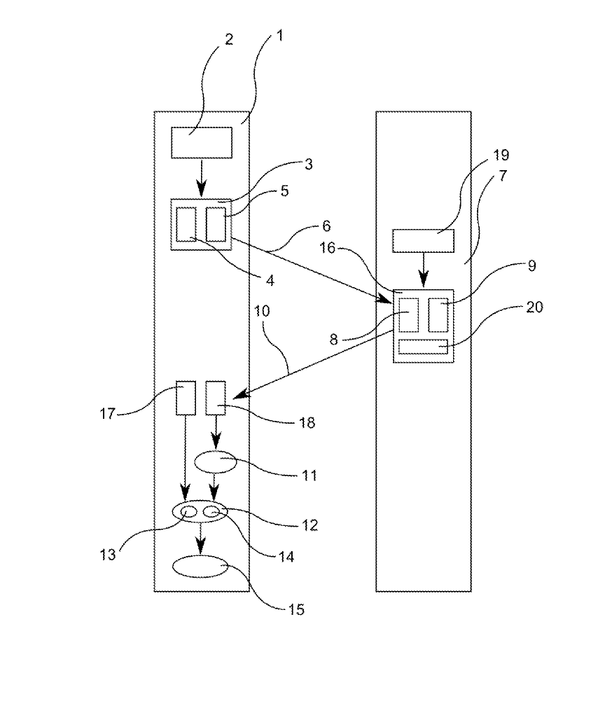

### CROSS-REFERENCE TO RELATED APPLICATIONS

Priority is claimed to German Patent Application No. DE 10 2014 016 402.0, filed on Nov. 5, 2014, the entire disclosure of which is hereby incorporated by reference herein.

### FIELD

The invention relates to a method for the exchange or for the update of an old device of a process control system.

### BACKGROUND

Process control systems, such as those in automation plants, generally comprise man-machine interfaces such as display systems and control stations, as well as process-oriented components, as for example SPS plants, which consist of devices, which are for example used for the administration or the control of field devices. These field devices are physical devices, which physically interact with the process in any form. They can for example be actuators or thermoelectric components or sensors. Such process control systems are used, amongst other things, in a plurality of industrial applications, and possibly require an exchange or an upgrade or an update of individual devices.

Such maintenance measures are generally not executed in an automated manner but they must be adapted to the special applications. Even if a device of a certain type by a certain manufacturer is exchanged with a new device of the same type by the same manufacturer, these two devices are not necessarily identical, which means that certain parameters and behaviors affecting the device can differ, so that past parameter values, description data of the device, and tools affecting the device cannot simply be taken over. Even if only one software update is to be executed, thus a change of the firmware of a physical device, operational parameters must possibly be adapted. This leads to outages of devices or process chains and also to technically outdated process control systems, as exchanges and updates of old devices are preferably postponed or avoided due to the technical difficulties occurring therewith.

A method for the exchange of a field device to be replaced is known from DE 102007026678A1, wherein parameters affecting the field device are compared with parameters of the new field device with regard to at least one data set via an electronic control unit communicating over a field bus, in order to possibly adapt the parameters according to the old field device. Such solutions integrated into a process control system are disadvantageous in that an individual process control system typically only has a small number of pairings of old and new devices, and that thus less or no empirical values are present, how to adapt a new device with regard to its parameters.

### SUMMARY

An aspect of the invention provides.

### DETAILED DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

The FIGURE shows the schematic sequence of a method according to the invention.

### DETAILED DESCRIPTION

An aspect of the invention relates to a method for the exchange or for the update of an old device of a process control system, wherein information is collected about the type and the entity of the old device as well as the type of a new device. An aspect of the invention further relates to a process control system which is suitable for the execution of this method. An aspect of the invention extends its application to automation plants, as for example process control systems.

An aspect of the present invention provides a method which simplifies the exchange or the update of devices of a process control system.

An aspect of the invention includes the technical teachings that the information is compiled into a request, and the request is forwarded to an external service system, by means of which the request is analyzed and processed, whereupon at least the specification of a new device is compiled and is transferred to the process control system in a transfer step and is integrated into the process control system. The specification thereby comprises at least the type, the version, the configuration and the parameterization of the device.

It is favorable here that an arbitrary large number of process control systems can possibly access the same external service system. Thereby, an extensive know-how can develop in this external service system, which extends to parameter modifications of new devices in dependence on the respective objects and special characteristics of the respective process control system. While for example the exchange of a certain device with a new version of this same device usually must be executed only once in a certain process control system, wherein no empirical values are then present for this exchange, then exactly this exchange can present a typical application, seen over a large number of process control systems which are independent amongst themselves, for example belonging to different operators.

A preferred embodiment of the invention provides that an expert is selected by the external service system, by whom the new device is compiled. It is favorable here that, for example by categorization of the type of device and allocation to the special fields of the respective experts, an expert can be selected who is familiar with the special requirements and for example parameter modifications, which is required by the respective exchange. Thereby, in particular a substantial part, possibly also the entire effort of an exchange or an update, is diverted outwards from the process control system, and the quality or the reliability of the new device is increased in principle.

One measure improving the invention provides that the specifications of the new device are stored in a database. These specifications refer mainly to the parameters or to the parameterization of the new device in connection with the old device.

It is advantageous hereby that for example an expert can simply gain knowledge about the necessary or recommended parameter modifications of the new device by viewing the database.

A preferred embodiment of the invention provides that the external compilation is executed in an automated manner by access to the database.

It is hereby mainly advantageous that, by means of the existence of such a database, typical maintenance questions of different process control systems or those occurring frequently during use, must not necessarily be looked after by experts, but can be processed in an automated manner by comparison with identical or similar entries of the database. This means a decrease of possible, for example human, error sources in addition to time and cost savings.

An improvement of the invention provides that, together with the request, a further request or an order of a physical, parameterized device is passed to the external service system, which is provided by the service system and which is physically transferred into the process control system for integration.

An advantage of these additional process steps is to be seen in the fact that, in addition to the exchange of for example the software or the cyber representation of a device in the form of a virtual device, the exchange of a physical device with the other advantages relating to the invention can also be executed.

A preferred embodiment of the invention provides that the analysis on the part of the external service system comprises the preparation and transmission of an offer. This offer can for example also be the conclusion of a sales contract relating to the new device or for example also the conclusion of a service contract relating to parameterization and the installation of the new device. It is also possible, when preparing such an offer, the purchase price is adapted in dependence on for example the operator of the process control system. It is advantageous hereby that possibly, in particular with the presence of a corresponding process control system, such an offer can be accepted in an automated manner, whereby exchanges and updates of for example virtual and physical devices of the process control system can be executed virtually or completely in an automated manner.

An improvement of the present invention provides that, after the integration of the new device into the process control system, an update of the firmware or a download of parameters into the device are executed. The advantage of this embodiment form can be seen in the fact that a gradual integration of the new device into the system can possibly be executed.

Preferably, a virtual device is in particular exchanged with a new virtual device. It is advantageous hereby that this exchange can be executed completely without physical interference. Just such an exchange can possibly be executed in a completely automated manner and without the interference for example by experts or maintenance staff of the process control system.

The invention process control system concerned has one logic unit communicating with an external service system for the execution of the aforementioned process.

In accordance with the FIGURE, an old device 2 or a function of an old device 2 is provided in a process control system 1 for an exchange or for an update. Thus a request 3 is compiled, which contains information 4 about the type and the entity of the old device as well as about the type of the new device and which optionally also contains a request for a parameterized physical device 5. This request 3 is forwarded to an external service system 7 in a forwarding step 6, whereupon the process control system 1 awaits the arrival of an answer 16 from the external service system 7.

The request 3 is analyzed in this external service system 7 and is processed by a comparison of the statements contained in the request 3 with a database 19, in particular by the preparation of a new virtual device 8 of a virtual device and optionally, as here, additionally by the parameterization of a physical device 9 as well as by the preparation of a purchase-contractual offer 20. An entity 17 of the new virtual device 8 is transferred to the process control system 1 in a transfer step 10, and optionally parallel to this, the new parameterized physical device 18. If, as here, a parameterized physical device 18 was transferred, it is installed into the process control system 1 in an installation step 11 by maintenance staff. Possibly, an update 13 of the firmware or a download 14 of parameters or functional expansions can be executed on the new entity 17 of the virtual device 8 in a further configuration step 12. In a last step, the operation 15 of the process control system is continued.

The invention is not limited to the above-described preferred exemplary embodiment. Rather, modifications thereof are conceivable, which are also included in the scope of protection of the following claims. It is thus for example also possible to forgo the download of parameters or the update of firmware in the process control system, in that these corresponding steps are for example already executed within the external service system.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

1 Process control system
2 Old device
3 Request
4 Information
5 Request for a parameterized physical device
6 Forwarding step
7 External service system
8 Virtual device
9 Physical device
10 Transfer step
11 Installation step
12 Configuration step
13 Update
14 Download
15 Operation
16 Answer
17 New entity
18 Parameterized physical device
19 Database
20 Offer

1. A method of exchanging or updating an old device of a process control system, the method comprising:
collecting information about a type and entity of the old device as well as the type of a new device;
compiling the information into a first request; and
forwarding the first request to an external service system;
analyzing and processing the first request using the external service system;
externally compiling and transferring at least a specification of the new device to the process control system; and
integrating at least the specification into the process control system.

2. The method of claim 1, further comprising:
selecting an expert by the external service system, by whom the new device is compiled.

3. The method of claim 1, further comprising:
storing the specification of the new device in a database.

4. The method of claim 3, wherein the externally compiling includes execution in an automated manner by access to the database.

5. The method of claim 1, further comprising:
together with the first request, forwarding a second request for a parameterized physical device to the external service system,
wherein the second request is provided by the external service system and transferred as part of the externally compiling and transferring for integration into the process control system.

6. The method of claim 1, further comprising:
creating an offer by the external service system; and
communicating the offer to the process control system.

7. The method of claim 1, further comprising, after the integrating of the new device:
executing an update of parameters into the new device.

8. The method of claim 1, further comprising, after the integrating of the new device:
executing a download of parameters into the new device.

9. The method of claim 1, further comprising, after the integrating of the new device:
executing an update and a download of parameters into the new device.

10. The method of claim 1, comprising exchanging a virtual device.

11. The method of claim 1, comprising updating a virtual device.

12. The method of claim 1, comprising expanding a virtual device.

13. A process control system, comprising:
an old device suitable for an exchange or an upgrade;
wherein the old device includes an arithmetic unit configured to communicate with an external service system for executing the method of claim 1.

14. The system of claim 13, wherein the old device is a virtual device.
